(19) United States
(12) Patent Application Publication
(10) Pub. No.: US 2015/0116285 A1
(43) Pub. Date: Apr. 30, 2015

(54) METHOD AND APPARATUS FOR ELECTRONIC CAPTURE OF HANDWRITING AND DRAWING

(71) Applicant: Michael A. Kling, Sunnyvale, CA (US)

(72) Inventor: Michael A. Kling, Sunnyvale, CA (US)

(21) Appl. No.: 14/064,198

(22) Filed: Oct. 28, 2013

(51) Int. Cl. G06F 3/0354

(52) U.S. Cl. CPC G06F 3/03545
USPC 345/179

(57) ABSTRACT

With electronic documents increasingly replacing paper based ones there is a need to convert handwriting and drawing into electronic formats. Current solutions have significant drawbacks due to their bulkiness, cost and limited performance. The proposed invention describes a new compact, light weight and low power system capable of electronically capturing handwriting and drawing. This invention enables the use of tiny MEMS based sensors such as accelerometers, gyroscopes and magnetometers to capture the user's hand motion in real time. It employs specialized algorithms taking advantage of the unique characteristics of human handwriting and drawing to enable the embedded software to accurately reproduce the pen strokes from the raw sensor data.

### FIELD OF THE INVENTION

This invention relates generally to the fields of human computer interfaces, inertial measurement and motion tracking.

### BACKGROUND

With electronic documents increasingly replacing paper based ones it is desirable to convert human expressions such as writing and drawing into electronic form. Conventional methods of doing so have a number of inherent shortcomings that prevent them from replicating the natural feel of paper based writing.

One existing method of converting writing and drawing into electronic form is by using an electronic pen that has a miniature camera in its tip. The camera recognizes microscopic patterns on special paper that allows the pen to track the writing. This method requires special paper to work and makes the pen bulky and expensive due to the need for a camera and image processing hardware.

Another existing method is based on ultrasonic location. This typically works with regular paper, however, it requires a specially equipped notepad or clip-on adapter that contains ultrasound transceivers. The pen also has an ultrasonic transceiver and the system uses timing measurements of ultrasonic signals between the pen and the notepad to determine the pen's position.

Another common method nowadays is to use a stylus with a computer tablet or special writing surface. The underlying technology for digitizing the motions of the stylus can be optical, pressure based or by capacitive sensing. These methods are limited in accuracy by the resolution and speed of the digitizer technology and have the least natural feel compared to writing on paper.

The purpose of the invention is to overcome the limitations of current handwriting capture methods and provide a lightweight, low cost, low power mechanism that is easy to use for various applications.

### SUMMARY

The invention is comprised of an apparatus that can be clipped onto or integrated into any pen, pencil, marker, stylus or other handheld writing instrument. Its small size, battery powered operation and optional wireless communications make it unobtrusive and convenient to use. The invention employs inertial sensors that translate the motions of the pen into electronic signals that are captured and processed by a microprocessor or similar embedded CPU. It also employs a method, implemented in software that translates those electronic signals into a vector based representation of the writing. With this invention it is possible to electronically record written notes without the need for special paper or other bulky recording devices attached to the writing surface. It is compatible with any paper or other writing surface, any ink and even touch screens. Another application is the capture of signatures in credit card terminals where current technologies exhibit severe degradation of the recorded writing due to lack of speed and resolution of the current digitizer technologies.

### BRIEF DESCRIPTION OF THE DRAWINGS

FIG. 1 is a diagram depicting the electronic pen with sensors and the writing surface, each with their own local coordinate systems.

FIG. 2 is a high level block diagram of the major components of the electronic pen as well as a diagram showing a wireless connection to a PC for displaying the captured data.

FIG. 3 is a flow chart showing the main components of the handwriting capture algorithm.

FIG. 4 is a diagram depicting how the earth's gravity vector relates to the pen's coordinate system in upright and tilted conditions.

FIG. 5 is a diagram depicting how the earth's magnetic field vector relates to the pen's coordinate system in upright and tilted conditions.

### DETAILED DESCRIPTION OF INVENTION

### Basic Definitions

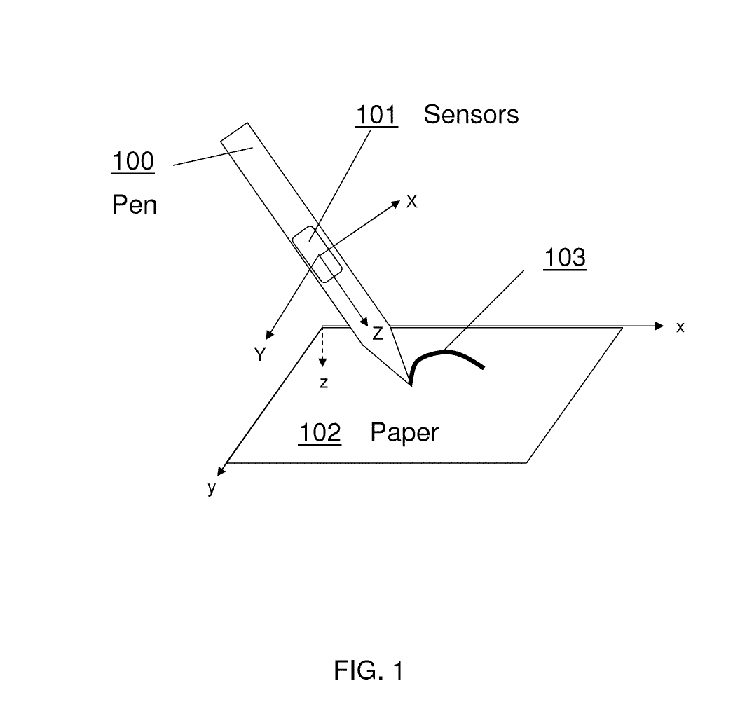

To introduce the concept of the invention consider FIG. 1. It depicts a pen 100 which is equipped with a set of inertial sensors 101. The sensors are assumed to measure inertial properties in three dimensional space, i.e., provide three outputs for the three dimensional spatial coordinates. The pen writes 103 on a writing surface such as a piece of paper 102. For the purpose of further describing the details of the invention the three dimensional moving coordinate system of the pen is referred to as {X, Y, Z}. Note that all sensor data is measured relative to this coordinate system. Conversely, the three dimensional fixed coordinate system of the paper is referred to as {x, y, z}. There are long established mathematical methods to convert between the fixed and moving coordinate systems using Euler angles, Tait-Bryan angles or quaternions. See “http://en.wikipedia.org/wiki/Euler_angles” or “https://pixhawk.ethz.ch/px4/dev/frames_of_reference” for details. Without loss of generality we will assume that the paper coordinate system is an earth-fixed NED (North-East-Down) frame.

Introducing further terminology, the set of accelerations as measured by the accelerometers of the pen is referred to as {a_{X}, a_{Y}, a_{Z}} corresponding to the pen's coordinate system. Similarly, there is a set of velocities {v_{X}, v_{Y}, v_{Z}} utilizing the same coordinate system.

Additionally, there exists a set of rotation velocities {ω_{X}, ω_{Y}, ω_{Z}} as measured by the gyroscopes of the pen and associated with the {X, Y, Z} coordinate system using the mathematical “right hand rule” to define their direction. Finally, there is a set of angles {Θ, Φ, Ψ} with respect to the same coordinate system.

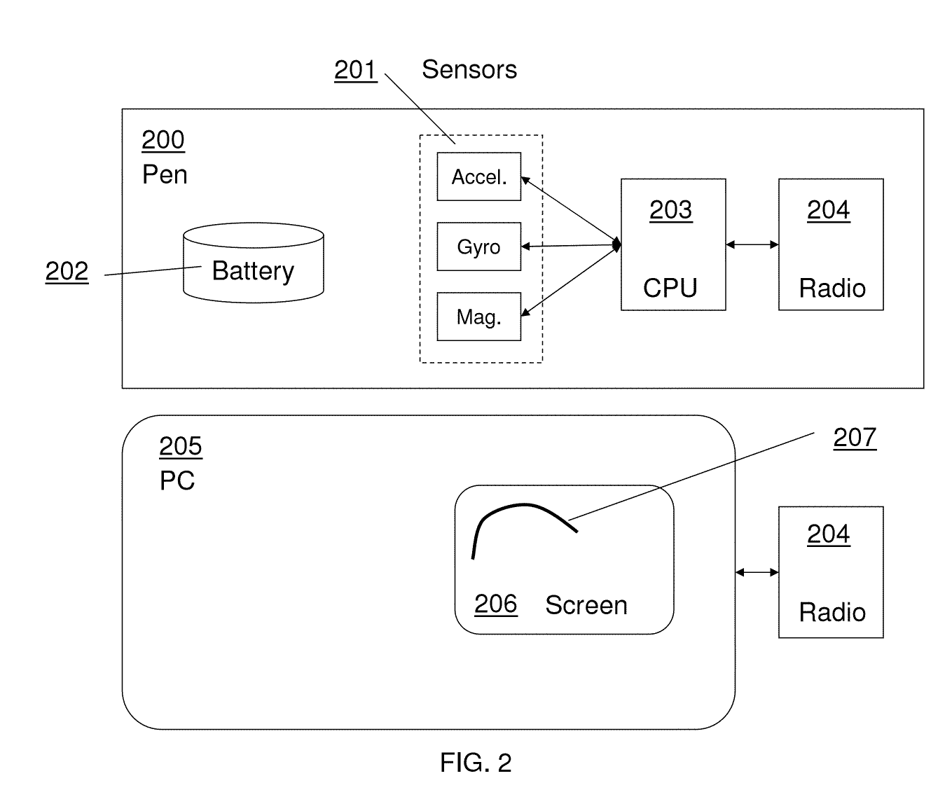

Without loss of generality we will further describe the invention using a particular embodiment shown in FIG. 2. In this case the pen 200 is equipped with a set of inertial sensors 201 consisting of a 3D accelerometer, a 3D gyroscope and a 3D magnetometer. Different embodiments may have fewer or more sensors. A particular variation of this embodiment includes a pressure sensor that indicates if the tip of pen touches the writing surface. This addition provides further useful information to the 2D plane filter described below.

This particular embodiment further comprises a microprocessor or microcontroller 203 which is used to process and buffer the sensor data. The system is powered by a small battery 202. Finally, a wireless radio 204 links the pen with an external computer 205 which typically would be a PC or handheld device such as a smart phone or tablet. This device can have a display 206 which can be used to display the pen's writing 207. It should be noted that some embodiments do not include a screen on the host device but directly store the data in a database for further processing.

We will now discuss the inertial sensors that are used in this invention and how their raw data is converted into the format needed for handwriting and drawing capture. The sensors are sampled periodically with time interval dt. The fundamental operation of an accelerometer is to measure acceleration. This acceleration data needs to be integrated over time to obtain velocity as given by the following equation:

v_{X}=v_{0X}+∫a_{X}dt (1)

The term v_{0X} indicates the velocity calculated in the previous sampling period. This applies to all three orthogonal coordinates resulting in the transformation of the acceleration data {a_{X}, a_{Y}, a_{Z}} into the velocity data {v_{X}, v_{Y}, v_{Z}}. Furthermore, the velocity data needs to be integrated over time again to obtain position data per the following equation:

X=X₀+∫v_{X}dt (2)

The term X₀ indicates the position calculated in the previous sampling period. Again, this calculation applies to all three orthogonal coordinates {X, Y, Z}.

The gyroscope raw data represents rotation velocity {ω_{X}, ω_{Y}, ω_{Z}} which needs to be converted to tilt angles {Θ, Φ, Ψ} by the following equation:

Θ=Θ₀+∫ω_{X}dt (3)

The term Θ₀ indicates the angle calculated in the previous sampling period. Again, this calculation applies to all three orthogonal coordinates {X, Y, Z}. The time period dt for the integration is chosen to be small enough (typically a few milliseconds) to capture enough details of the handwriting motion in order to be able to recreate it with high fidelity. The smaller the time period, the more processing power and data bandwidth are required, however.

### System Operation

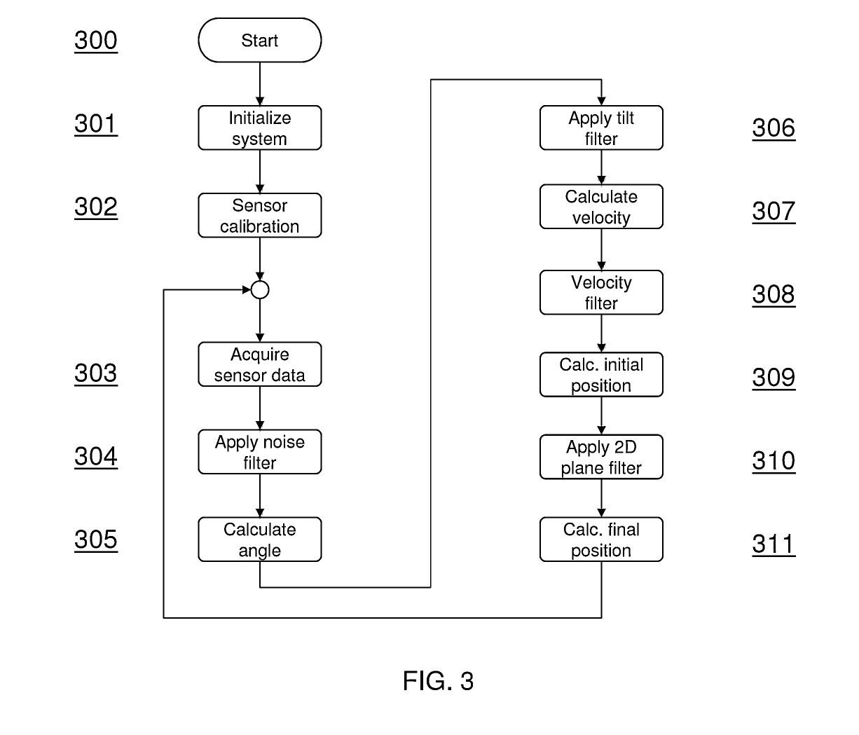

The flow chart in FIG. 3 explains how one typical embodiment of the invention operates. When the power is applied to the pen the system boots 300 and starts initializing 301. This configures all the hardware components to be ready for operation. The next phase is sensor calibration 302 which typically requires the pen to be held upright, still and touch the writing surface. This allows the system to estimate the sensor biases and remove them by setting appropriate calibration values. For example, the X axis accelerometer may show a reading of 0.01 m/s², however, in a perfect system it should read 0 m/s². The bias of 0.01 m/s² will be recorded as a bias offset and subtracted from a_{X} measurements in the future.

The calibration procedure also establishes a relationship between the pen's moving coordinate system {X, Y, Z} and the paper's fixed coordinate system {x, y, z} as follows. Consider the calibration to happen at time t₀. Thus, the following equations apply aligning the two coordinate systems by definition:

X(t₀)=x(t₀)=0;Y(t₀)=y(t₀)=0;Z(t₀)−Z_{off}=z(t₀)=0; (4)

The constant Z_{off} describes the distance between the tip of the pen and the origin of the Z coordinate. The calibration steps may be repeated at different points of the writing surface to establish its size and calculate scale factors.

Another important function of the calibration procedure is to establish the direction of the gravity vector which should be aligned as closely as possible with the pen's Z coordinate. Gravity produces a constant and known acceleration of 9.81 m/s² downward which needs to be subtracted from the measurements. This is particularly important when the pen is tilted and a portion of the gravity vector overlaps with the pen's X or Y coordinates and therefore distorts the accelerometers' measurements of hand motion in the drawing plane.

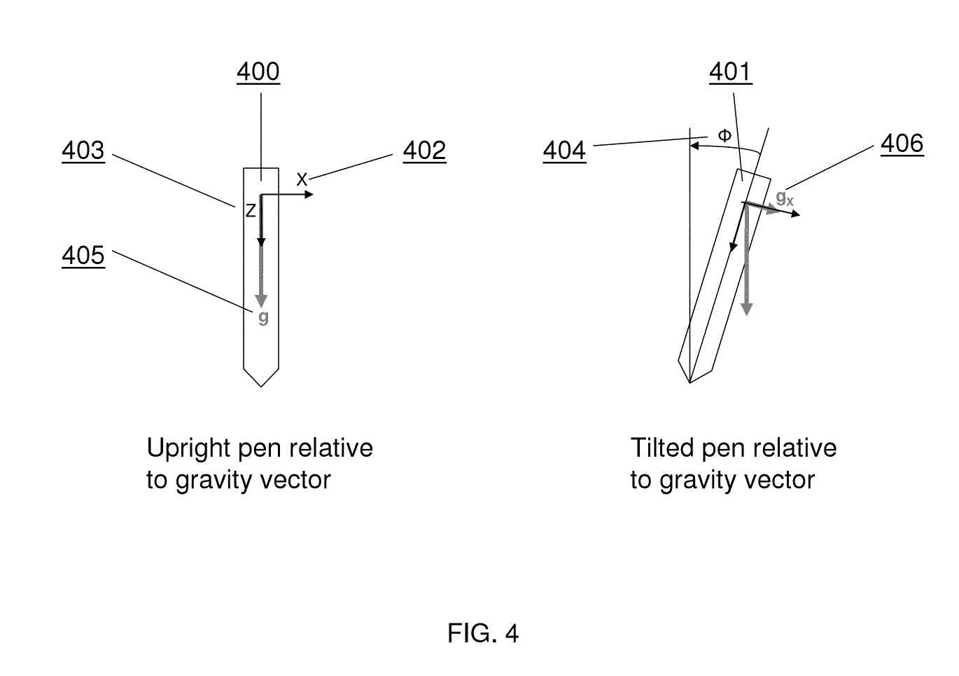

Consider FIG. 4 for a detailed explanation. The upright pen 400 has its Z coordinate 403 aligned with the direction of the gravity vector g 405. In this case it is simple to subtract the gravity constant from the acceleration in the Z axis a_{Z}. The X and Y measurements are not impacted by gravity in this case.

The situation changes when the pen is tilted 401 with a tilt angle Φ 404. In this case the gravity vector g is not orthogonal to the {X, Y} plane 402, 403 and its component gₓ 406 interferes with the X axis hand motion measurement (an analogous situation applies to the Y and Z axes which are not shown). The component gₓ can be calculated as gₓ=g*sin(Φ). Note that in this situation the total acceleration in the fixed x coordinate will be a properly scaled superposition of X and Z acceleration measurements.

Continuing with FIG. 3; after calibration, the system starts its regular capture processing loop which is typically executed in a particular time interval dt, e.g., every 10 milliseconds. The first step is to acquire sensor data form the accelerometers, gyroscopes, magnetometers and any other sensors present in the system. The raw data is then typically passed through a noise filter 304 which is often a simple averaging procedure to reduce noise spikes in the sensor data.

The next step 305 is to calculate the tilt angle of the pen. This can be done in several ways and depends on the type of sensors present in the system. One method uses the gyroscope in which the raw angular velocity data {ω_{X}, ω_{Y}, ω_{Z}} is integrated into tilt angles {Θ, Φ, Ψ}. For the X-Z plane, the computed angle Φ ideally corresponds to the pen's actual tilt angle which can then be used to subtract the gravity component gₓ from the hand motion acceleration a_{X}. A similar procedure applies to the X-Y and Y-Z planes.

If a magnetometer is present in the system it provides an alternate way to compute the pen's tilt angle. The basic assumption is that the earth's magnetic field direction stays constant over the comparatively small area of the writing surface. Thus the magnetic field direction can be used as a reference for the pen's tilt angle.

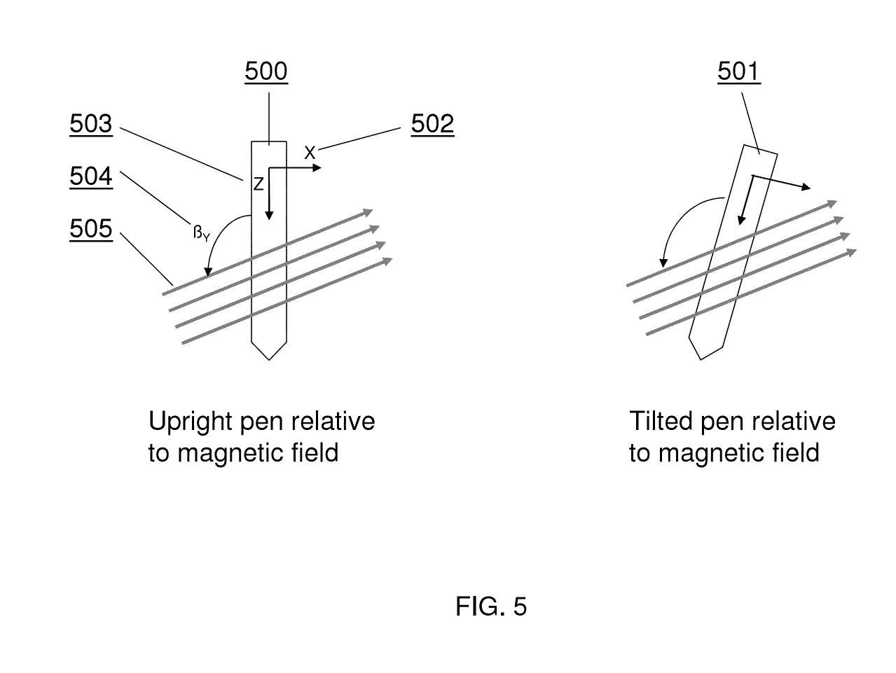

Consider FIG. 5 for details; again only the X-Z plane is shown with the X-Y and Y-Z plane calculations being analogous. During the calibration phase the pen 500 had been held upright with its Z axis 503 pointing downwards. This allowed establishing the angle β_{Y} 504 between the earth's magnetic field 505 and the pen's X-Z plane 502, 503. In the tilted pen case 501 the angle β_{Y} changes with the amount of tilt as the magnetic field lines stay fixed. The difference in the β_{Y} measurement compared to its value at initialization corresponds to the actual tilt angle Φ and can be used to subtract the gravity vector gₓ as described above using FIG. 4.

Continuing with FIG. 3; step 306 is the application of the tilt filter as described previously using the gyroscope and/or the magnetometer methods. After the acceleration vectors {a_{X}, a_{Y}, a_{Z}} are stripped of all gravity components they are used to calculate a set of velocity vectors {v_{X}, v_{Y}, v_{Z}} in step 307. The next step is to apply a velocity filter 308 which is a key component of this invention as described below.

The problem that is solved by the velocity filter is that small errors in the acceleration values {a_{X}, a_{Y}, a_{Z}} can result in large position errors as they accumulate during the integration phases. A key observation about human handwriting and drawing is that periods of constant velocity with no acceleration present are very rare in this context. Typical pen strokes consist of brief acceleration periods almost immediately followed by deceleration. This fact can be used to provide a key correction to the velocity data {v_{X}, v_{Y}, v_{Z}} before it is being integrated into position data. The velocity filter operates by keeping a history of acceleration data. The following computation shows its operation for the coordinate (similar operation for Y and Z):

IF (a_{X}(t) . . . a_{X}(t−Δ)==0) THEN v_{X}(t)=0 (5)

The variable t denotes the current measurement time while Δ specifies a time interval into the past which encompasses a number of discrete sample intervals.

In essence the velocity filter examines the acceleration values from the current sample time t and all samples over the past interval Δ. If all those acceleration values are equal or close to zero indicating that the pen was not accelerated over that time period it is assumed that the pen was held still. In this case any non-zero velocity measurement v_{X}(t) must be due to an error rather than an actual velocity caused by hand motion. Therefore, that velocity is subtracted from the current measurement. This method is very effective in removing accumulated sensor errors.

After the velocities are corrected an initial 3D pen position {X, Y, Z} is calculated in step 309 by integrating the velocity vectors {v_{X}, v_{Y}, v_{Z}}. Subsequently, another correction of the data is applied using a 2D plane filter. This filter exploits the fact that while writing or drawing is performed the tip of the pen touches the writing surface. As it is impossible for the pen to penetrate the writing surface any coordinates that implies a negative offset from the surface's fixed z=0 coordinate can be corrected.

The detailed operation is as follows: In the calibration phase 302 when the pen was held upright to the writing surface the relation between the origin of the pen's moving {X, Y, Z} coordinates and the origin of the paper's fixed {x, y, z} coordinates was established as discussed above. Furthermore, the offset between the tip of the pen and the origin of the {X, Y, Z} coordinate system where the sensors are located was compensated for by subtracting the fixed distance between the two points Z_{off}.

In the filter phase 310 current vertical position data z(t) of the pen's tip with respect to the fixed coordinate system is compared to the fixed plane of the paper and used to determine whether the pen touches the surface. The following procedure describes the calculation:

IF (z(t)<=0) THEN {pen_down=TRUE} ELSE {pen_down=FALSE} (6)

If the tip of the pen is above the surface the system will not record a drawn line segment for the current time interval as the pen is assumed to be lifted from the paper. If the pen is equal or lower than the surface a line segment from the pen's previous x, y coordinates to its current x, y position will be recorded. Furthermore, any negative z offset (pen would be penetrating the surface) will be corrected. The final {x, y, z} position of the pen will be recorded in step 311 along with whether a line should be drawn.

If the system includes a pressure sensor that indicates the tip of the pen touching the surface further corrections can be made in step 310. Calculation (6) will still be performed, however, the decision on whether to record a line will be based on the pressure sensor (if pressure is detected, draw a line, else do not draw a line). Knowing the fact that the pen touches the surface can be used to correct the pen's z value obtained from step 309. In this case the z value is corrected to zero.

After final time, position, velocity, angle and raw sensor data are recorded for record keeping purposes in step 311 the algorithm loops back to step 303 for another iteration after time interval dt elapsed. The basic algorithm described above can be enhanced by more sophisticated methods of processing raw sensor data and keeping track of error states such as Extended Kalman filters which are common in inertial systems. Nonetheless, the basic functions of the invention described by the methods: tilt filter, velocity filter and 2D plane filter which impose constraints derived from the mechanics of human handwriting and drawing still apply.

What is claimed is:

1. A system designed to electronically capture three dimensional movements constrained to a two dimensional plane comprising of:
a handheld device
inertial sensors comprised of accelerometers, gyroscopes and optional magnetometers tracking the motion of the user's hand motion
including at least one of the following subsystems: a communication link between the handheld device and a secondary external computing device or a local data store for subsequent data retrieval.

2. The tracking system of claim 1 further comprising of an embedded microprocessor and memory to locally process and store handwriting and drawing data.

3. The tracking system of claim 1 adding a pressure sensor to indicate contact with the writing surface.

4. The tracking system of claim 2 adding a pressure sensor to indicate contact with the writing surface.

5. The tracking system of claim 1 integrated into the form factor of a pen providing both the functionality of a traditional pen as well as electronic handwriting and drawing capture.

6. The tracking system of claim 2 integrated into the form factor of a pen providing both the functionality of a traditional pen as well as electronic handwriting and drawing capture.

7. The tracking system of claim 3 integrated into the form factor of a pen providing both the functionality of a traditional pen as well as electronic handwriting and drawing capture.

8. The tracking system of claim 4 integrated into the form factor of a pen providing both the functionality of a traditional pen as well as electronic handwriting and drawing capture.

9. The tracking system of claim 1 integrated into the form factor of a white board marker providing both the functionality of a traditional marker as well as electronic handwriting and drawing capture.

10. The tracking system of claim 2 integrated into the form factor of a white board marker providing both the functionality of a traditional marker as well as electronic handwriting and drawing capture.

11. The tracking system of claim 3 integrated into the form factor of a white board marker providing both the functionality of a traditional marker as well as electronic handwriting and drawing capture.

12. The tracking system of claim 4 integrated into the form factor of a white board marker providing both the functionality of a traditional marker as well as electronic handwriting and drawing capture.

13. A method comprising of:
electronically capturing the data from the inertial sensors
processing the data from the inertial sensors by integrating the acceleration and angular rotation information to compute a three dimensional position
applying filtering algorithms to the data that eliminate noise and other artifacts and are based on the constraints of human handwriting or drawing.

14. The method of claim 13 in which one of the filtering algorithms is a tilt filter.

15. The method of claim 13 in which one of the filtering algorithms is a velocity filter.

16. The method of claim 13 in which one of the filtering algorithms is a two dimensional plane filter.

17. The method of claim 16 in which the two dimensional plane filter is assisted by data from a pressure sensor.
